(19) United States
(12) Patent Application Publication
(10) Pub. No.: US 2017/0207466 A1
(43) Pub. Date: Jul. 20, 2017

(54) LAMINATE-TYPE POWER STORAGE ELEMENT

(71) Applicant: FDK CORPORATION, Tokyo (JP)

(72) Inventors: Naoaki Nishimura, Tokyo (JP); Tsukasa Mano, Tokyo (JP); Daisuke Hirata, Tokyo (JP); Yuki Ochiai, Tokyo (JP); Akihiro Yamamoto, Tokyo (JP)

(21) Appl. No.: 15/411,591

(22) Filed: Jan. 20, 2017

(30) Foreign Application Priority Data
Jan. 20, 2016 (JP) 2016-008866
Dec. 26, 2016 (JP) 2016-250860

(51) Int. Cl. H01M 6/40; H01M 2/30

(52) U.S. Cl. CPC H01M 6/40; H01M 2/30; H01M 2220/30

(57) ABSTRACT

A laminate-type power storage element, including an exterior body that is formed in a flat bag shape, an electrode body that has a sheet-shaped positive electrode and a sheet-shaped negative electrode and that is sealed inside the exterior body, a positive electrode terminal plate that is mounted to the positive electrode and that is made of a metal that forms an oxide film, and a negative electrode terminal plate that is mounted to the negative electrode and that is made of a metal that forms an oxide film, wherein the positive electrode terminal plate and the negative electrode terminal plate are guided in an identical direction from one margin of the exterior body to an outside of the exterior body, and have anisotropic conductive paint applied over respective principal surfaces thereof facing an identical side.

### CROSS-REFERENCE TO RELATED APPLICATIONS

The present application claims the benefit of priority pursuant to 35 U.S.C. §119(a) to Japanese Patent Application No. 2016-8866 filed on Jan. 20, 2016 and Japanese Patent Application No. 2016-250860 filed on Dec. 26, 2016, the entire disclosure of which are herein incorporated by reference.

### BACKGROUND

Technical Field

Embodiments of this disclosure generally relate to a laminate-type power storage element that houses a power generation element in an exterior body formed of laminated films.

Related Art

As a form of a power storage element such as a primary battery, a secondary battery, and an electric double layer capacitor, there has been provided a laminate-type power storage element that seals a flat plate-shaped electrode body, including a sheet-shaped positive electrode and a sheet-shaped negative electrode in a flat-bag-shaped exterior body formed of laminated films. Since the laminate-type power storage element easily achieves both a large capacity and downsizing and thinning and is also excellent in heat radiation performance, the laminate-type power storage element has been conventionally used as a power supply for driving an electric vehicle, a hybrid vehicle, or a similar vehicle. Recently, utilizing the feature of being easily downsized and thinned, the laminate-type power storage element has been used as a power supply for an extremely thin electronic device (hereinafter, a thin electronic device) that incorporates a power supply, such as an IC card with a one-time password function and a display, an IC card with display, a tag, and a token (one-time password generator). Especially, an external dimension of a card type electronic device (card electronic device) compliant to a standard for IC card is specified by the standard, and the thinness is extremely thin, 0.76 mm. Therefore, the laminate-type power storage element is indispensable as a power supply for the card electronic device.

FIGS. 1A and 1B illustrate a laminated lithium primary battery as a general laminate-type power storage element. FIG. 1A is an external view of a laminate-type power storage element 1, and FIG. 1B is an exploded perspective view illustrating an outline of an internal structure of this power storage element 1. As illustrated in FIG. 1A, the laminate-type power storage element 1 has a flat plate-shaped appearance. An exterior body 11 formed of laminated films shaped into a flat rectangular bag internally seals a power generating element. In the laminate-type power storage element 1 illustrated here, distal end parts (24 and 34) of a positive electrode terminal plate 23 and a negative electrode terminal plate 33 are guided to outside from one side 13 of the rectangular exterior body 11.

Next, the following describes a schematic structure of the laminate-type power storage element 1 with reference to FIG. 1B. FIG. 1B hatches some members and portions for easy distinction from other members and portions. As illustrated in FIG. 1B, the exterior body 11 internally seals an electrode body 10 together with electrolytic solution. The electrode body 10 is formed by laminating a sheet-shaped positive electrode 20 and a sheet-shaped negative electrode 30 via a separator 40. The positive electrode 20 is formed by disposing a positive electrode material 22 containing a positive-electrode active material over one principal surface of a positive electrode current collector 21 made of a metal plate and a metal foil. The negative electrode 30 is formed by disposing a negative electrode material 32 containing a negative-electrode active material over one principal surface of a negative electrode current collector 31 made of a metal plate, a metal foil, or a similar material. The electrode body 10 is configured by laminating and press-bonding the positive electrode 20 and the negative electrode 30 such that the respective electrode materials (22 and 32) are opposed via the separator 40 (or being welded to the separator 40). In this example, electrode terminal plates, which are formed of a strip-shaped metal plate, metal foil, or similar material, are mounted to the respective electrode current collectors (21 and 31) of the positive electrode 20 and the negative electrode 30.

The exterior body 11 is configured by welding peripheral edge regions 12, which are hatched or indicated by the dotted line frame in the drawing, of two rectangular laminated films (11a and 11b), which are stacked to one another, by thermocompression bonding to seal the inside. As is well-known, the laminated films (11a and 11b) have a structure where one or more resin layers are laminated on front and back of a metal foil (aluminum foil, stainless steel foil) serving as a base material. Generally, the laminated films (11a and 11b) have a structure where a protecting layer made of, for example, a polyamide resin is laminated on one surface and an adhesive layer with thermal weldability made of, for example, a polypropylene is laminated on the other surface.

A procedure to house the electrode body 10 in this exterior body 11 while the two laminated films (11a and 11b) are shaped into the flat-bag-shaped exterior body 11 is as follows. For example, the electrode body 10 is disposed between the two planar-rectangular-shaped laminated films (11a and 11b) opposed to one another. The three sides of the rectangle are welded and the one remaining side is formed into an opening, thus forming the bag shape. The one side 13 among these three sides is welded with the terminal plates (23, 33) of both the positive and negative electrodes (20 and 30) projected outside of the exterior body 11. Thus, after an injection of the electrolytic solution in the laminated films (11a and 11b), which are formed into the rectangular bag shape with the opening on one side, the peripheral edge regions 12 of the open one side are welded, thus finishing the laminate-type power storage element 1 illustrated in FIG. 1A.

Since the laminate-type power storage element is used as the power supply for electronic devices, to incorporate the laminate-type power storage element into the electronic device, the electrode terminal plates need to be coupled to an electronic circuit in the electronic device. One of the coupling methods employs an anisotropic conductive film (hereinafter also referred to as an ACF). As is well-known, the ACF is a film-shaped component for implementation, which has a conductive property only in a thickness direction. The ACF has a structure of dispersing conductive particles in a sheet-shaped adhesive resin. FIGS. 2A to 2D are drawings illustrating the method to implement the laminate-type power storage element to an electronic circuit board using the ACF. FIGS. 2A to 2D illustrate the implementation procedure. FIGS. 2A to 2D are enlarged views of a region near the electrode terminal in a cross section viewed from arrow a-a in FIG. 1A. First, as illustrated in FIG. 2A, the distal ends (24 and 34) of the electrode terminal plates (23, 33) are guided to the outside of the exterior body 11 in the assembled laminate-type power storage element. The positive electrode terminal plate 23 and the negative electrode terminal plate 33 are disposed separately in a direction orthogonal to the plane of the paper in the drawing. As illustrated in FIG. 2 B, a single ACF 70 is interposed between a power feeding terminal pad 61 and respective surfaces of the distal end sides (24 and 34) of the terminal plates (23, 33) of the positive electrode 20 and the negative electrode 30 (hereinafter also referred to as implementation surfaces 50). The power feeding terminal pad 61 is formed as a print wiring on a circuit board 60 such as a flexible printed circuit board (FPC) constituting the electronic circuit. That is, the one ACF 70, which extends in the direction orthogonal to the plane of the paper, is bridged across both electrode terminal plates (23, 33). As illustrated in the drawing, the implementation surfaces 50 of the electrode terminal plates (23, 33) are disposed to be lower surfaces and the relative up-down direction in the electrode terminal plates (23, 33) is specified. Then, as illustrated in FIG. 2C, the thermocompression bonding is performed from top surfaces 51 of the electrode terminal plates (23, 33) with, for example, a block-shaped jig 80 with built-in heater. As illustrated in FIG. 2D, this couples the electrode terminal plates (23, 33) of both positive and negative electrodes to the power feeding terminal pad 61 on the circuit board 60 via the one ACF 70.

For example, Non-Patent Literature 1 (Hitachi Chemical Co., Ltd., “Anisotropic Conductive Films ‘ANISOLM’,” [online], [searched on Dec. 22, 2015], Internet <URL: http://www.hitachi-chem.co.jp/japanese/products/do/001.html> (<URL: http://www.hitachi-chem.co.jp/english/products/do/001.html> in English)) describes a structure of the ACF, the implementation method using the ACF, or similar information. For example, Japanese Unexamined Patent Application Publication No. 2006-281613 discloses the structure of the laminate-type power storage element or similar information. The following Non-Patent Literature 2 (FDK CORPORATION, “Thin Type Primary Lithium Batteries,” [online], [searched on Dec. 21, 2015], Internet <URL: http://www.fdk.co.jp/battery/lithium/lithium_thin.html> (<URL: http://www.fdk.com/battery/lithium_e/lithium_thin.html> in English)) describes features, discharge performance, and a similar specification of the thin lithium batteries, actually commercially available laminate-type power storage elements.

To implement the laminate-type power storage element to the electronic circuit using the ACF, following the up-down direction illustrated in FIG. 2B to FIG. 2D, the jig is pressed from upward the electrode terminal plates to couple the electrode terminal plates to the circuit board via the ACF. That is, the ACF is heated via the electrode terminal plates made of metal excellent in thermal conductivity. The ACF is thermally welded to the terminal pad or a similar member on the circuit board. Generally, a temperature required to melt the adhesive resin, a base of the ACF, is around 140° C. However, the thermocompression bonding process presses the jig from the top surfaces of the electrode terminal plates and heats the adhesive for the film-shaped ACF up to a required melting temperature. The jig in contact with the top surfaces of the electrode terminal plates reaches a high temperature higher than the melting temperature of the adhesive resin (for example, 170 to 200° C.). Hereby, the heat of the jig is transmitted to the electrode body inside the exterior body via the electrode terminal plates, possibly damaging the electrode body.

When the laminate-type power storage elements are shipped as products, obviously, the ACF is not welded to the electrode terminal plates. This possibly would have a long time pass until the laminate-type power storage elements are implemented to the electronic circuits. For example, laminated batteries and the ACFs are stored as stock components at production sites for certain electronic devices. When the electronic devices are manufactured, using the stored laminate-type power storage elements and ACFs, these laminate-type power storage elements are implemented to the electronic circuits for electronic devices. The electrode terminal plate is often formed of a metal such as copper and aluminum, which forms an oxide film when placed in the air. The storage of the laminate-type power storage elements over a long period of time forms the oxide films in the electrode terminal plates. The oxide film increases a contact resistance between the electrode terminal plates and the ACP, possibly resulting in a poor coupling between the electrode terminal plates and the electronic circuit. Further, the ACF is an electronic component sold alone as a product, and the ACF is stored under refrigeration in principle. Accordingly, the implementation method using the ACF makes it difficult to provide the electronic device using the laminate-type power storage element at a lower price due to the component cost and the storage cost related to the ACF.

It is therefore an object of the present invention is to provide a laminate-type power storage element that does not damage an electrode body during an implementation by thermocompression bonding, restrains a formation of an oxide film in an electrode terminal even if the laminate-type power storage element is stored over a long period of time to ensure enhancing reliability in an implemented state and to also ensure a reduction in a production cost for an implemented electronic device.

### SUMMARY

Disclosed embodiments describe a laminate-type power storage element, including,

an exterior body that is formed in a flat bag shape;

an electrode body that has a sheet-shaped positive electrode and a sheet-shaped negative electrode and that is sealed inside the exterior body;

a positive electrode terminal plate that is mounted to the positive electrode and that is made of a metal that forms an oxide film; and

a negative electrode terminal plate that is mounted to the negative electrode and that is made of a metal that forms an oxide film, wherein

the positive electrode terminal plate and the negative electrode terminal plate are guided in an identical direction from one margin of the exterior body to an outside of the exterior body, and have anisotropic conductive paint applied over respective principal surfaces thereof facing an identical side.

The disclosed laminate-type power storage element can keep the electrode body from being damaged when the laminate-type power storage element is implemented to a circuit board using a thermocompression bonding technique. Additionally, the laminate-type power storage element ensures restraining a formation of the oxide film in the electrode terminal in the case where the laminate-type power storage element is stored over a long period of time. This ensures obtaining high reliability in the implemented state. This also allows a reduction in production cost of the electronic device using the power storage element as the power supply. Other effects will be apparent in the following description.

### BRIEF DESCRIPTION OF THE DRAWINGS

For a more complete understanding of the present invention and the advantages thereof, reference is now made to the following description taken in conjunction with the accompanying drawings wherein:

FIGS. 1A and 1B are drawings illustrating an example of a general laminate-type power storage element;

FIGS. 2A to 2D are drawings illustrating an implementation procedure for the laminate-type power storage element using an ACF;

FIGS. 3A and 3B are drawings illustrating a laminate-type power storage element according to a working example of the present invention;

FIG. 4 is a drawing illustrating a secular change of rates of increase in internal resistance in laminate-type power storage elements according to the working example of the present invention and a comparative example; and

FIG. 5 is a drawing illustrating a structure of a laminate-type power storage element according to another working example of the present invention.

### DESCRIPTION OF EXEMPLARY EMBODIMENTS

The following describes working examples of the present invention with reference to the attached drawings. Like reference numerals designate corresponding or identical elements in the drawings used for the following description, and therefore such elements may not be further elaborated. While a reference numeral is assigned to a part in a drawing, if unnecessary, the reference numeral may not be assigned to the corresponding part in another drawing.

### Process of Arriving at Present Invention

Conventionally, an implementation technique using an ACF is generally applied to couple mutual FPCs or the FPC and an electronic component (such as a liquid crystal display). Accordingly, the use of the ACF is natural when implementing a laminate-type power storage element to an electronic circuit. However, the use of the laminate-type power storage elements as power supplies for various electronic devices caused an unexpected problem. For example, with a laminate-type power storage element used as a power supply for compact, thin electronic device typified by a card electronic device, a heat generated during thermocompression bonding on the ACF transmits to an entire small electrode body in an exterior body, causing a problem of damage in the electrode body. As the applications of the laminate-type power storage elements increase, manufacturers of the electronic devices often store the laminate-type power storage elements as stock components similar to other many electronic components over a long period of time. That is, conventionally, a period from when the laminate-type power storage elements are shipped as the products until the laminate-type power storage elements are implemented was comparatively short, but now the laminate-type power storage elements are often implemented after the storage over a long period of time. Therefore, a problem of an increase in contact resistance caused by an oxide film generated in an electrode terminal plate cannot be ignored. The inventor has considered these newly perceived problems specific to the laminate-type power storage element and has hit upon the present invention through intensive studies on a configuration related to the implementation of the laminate-type power storage element.

### WORKING EXAMPLE

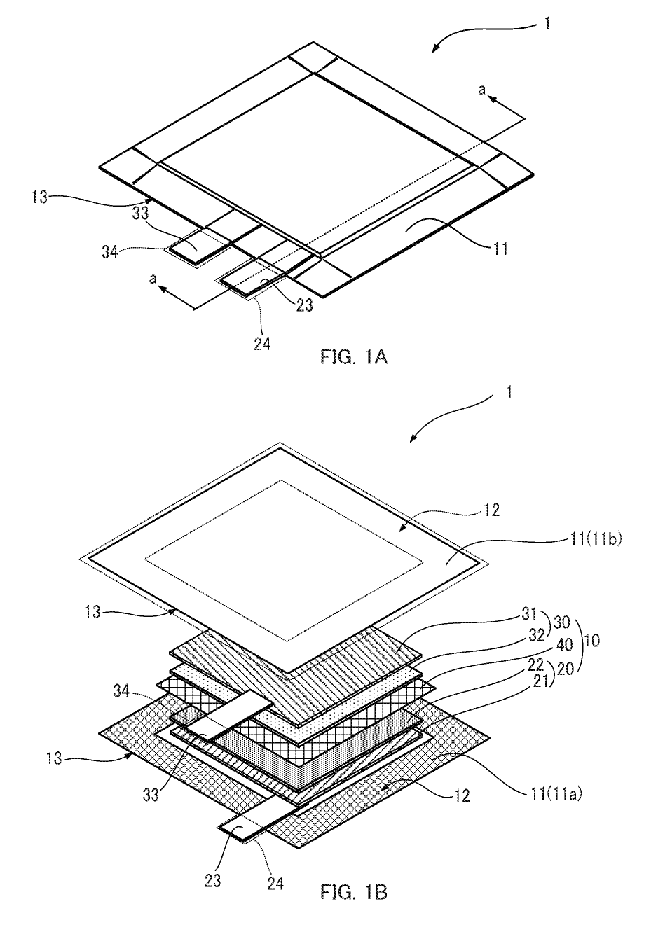

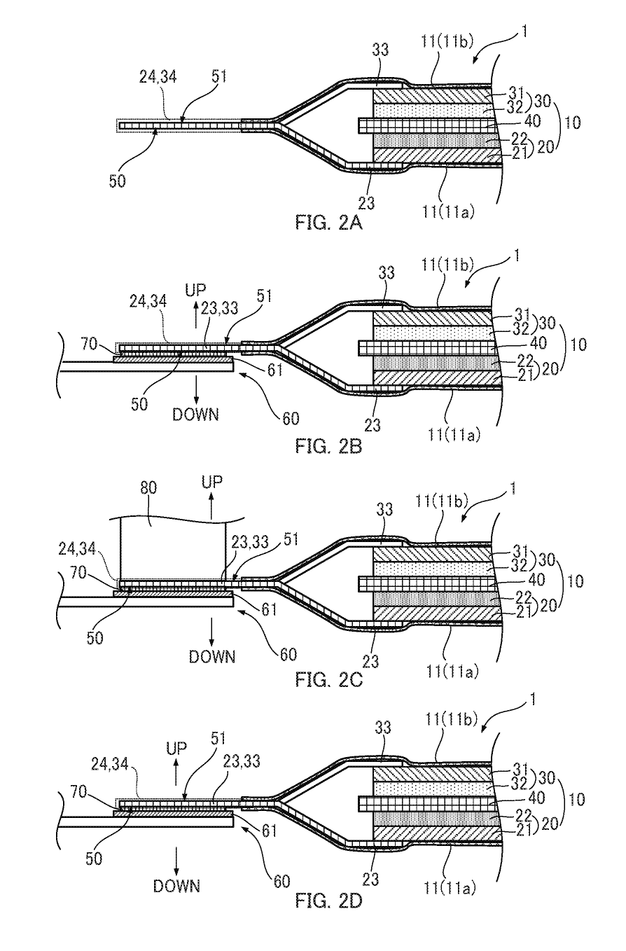

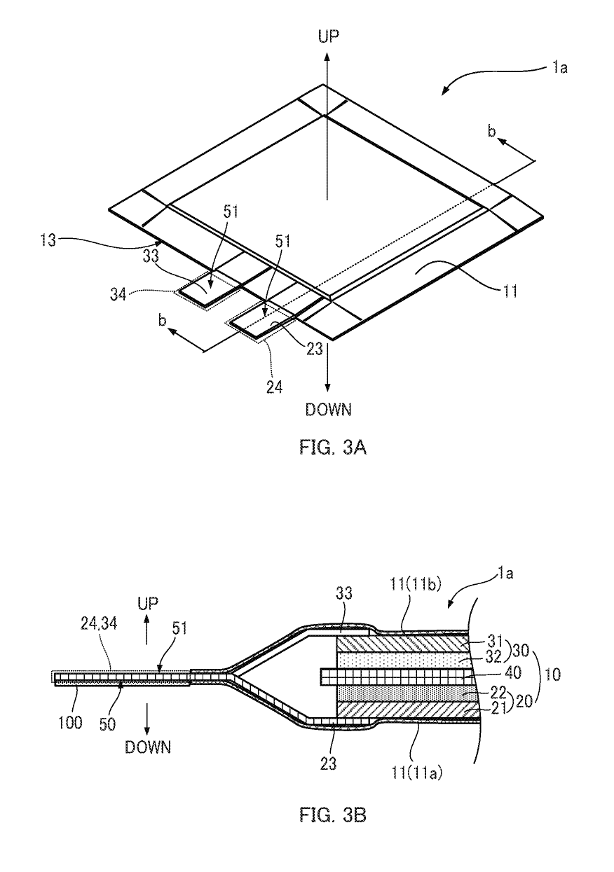

FIGS. 3A and 3B illustrate a laminate-type power storage element according to the working example of the present invention (hereinafter also referred to as a power storage element 1a). FIGS. 3A and 3B employ an up-down direction illustrated in FIGS. 2B to 2D. FIG. 3A is an external view of the power storage element 1a. FIG. 3B is a drawing enlarging a part of a cross section viewed from arrow b-b in FIG. 3A. As illustrated in FIG. 3A, an appearance of the power storage element 1a is similar to the general laminate-type power storage element 1 illustrated in FIG. 1A. An internal structure and a configuration of the power storage element 1a are basically identical to those of the general laminate-type power storage element 1. As illustrated in FIG. 3B, a material referred to as an anisotropic conductive paint or an anisotropic conductive adhesive (hereinafter also referred to as an ACP) is preliminarily applied over implementation surfaces 50 of electrode terminal plates. As is well-known, an ACP 100 is formed by dispersing metal particles in pastelike adhesive at a predetermined concentration. The ACP 100 hardens at a temperature at which a solvent in the adhesive is volatilized. Thermocompression bonding in the up-down direction develops a conductive property only in a thickness direction, thus bonding the implementation surfaces 50 of the electrode terminal plates (23, 33) and a coupling target (such as the terminal pad) in the electronic circuit together in the conductive state. In the power storage element 1a of the working example, the ACP 100 is applied over the implementation surfaces 50 of the electrode terminal plates (23, 33) by screen-printing.

A procedure to implement the power storage element 1a according to this working example to the electronic circuit is almost similar to the implementation procedure using the ACF 70 illustrated in FIGS. 2B to 2D. That is, instead of the ACF 70 in FIGS. 2B to 2D, a lower surface of the ACP 100 applied over the electrode terminal plates (23, 33) is brought into contact with a top surface of the power feeding terminal pad 61 of the circuit board 60. In this state, it is only necessary to perform the thermocompression bonding with a jig 80 for thermocompression bonding from the top surfaces 51 of the electrode terminal plates (23, 33) in the downward direction. This volatilizes a solvent component in the adhesive, and the metal particles in the adhesive come in contact with one another in the thickness direction. Thus, the electrode terminal plates (23, 33) and the power feeding terminal pad 61 are electrically connected.

Thus, the power storage element 1a of this working example uses the ACP 100 to couple the electrode terminal plates (23, 33) to the circuit board. It is only necessary that the thermocompression bonding process using the ACP performs the thermocompression bonding at a temperature at which the solvent in the ACP is volatilized. Even if the temperature of the jig (reference numeral 80 in FIG. 2C) is around 140° C., the practical adhesive strength is obtained. This keeps the electrode body from being damaged by the heat during the thermocompression bonding. That is, this improves the reliability of the power storage element 1a itself. Further, the power storage element 1a of the working example is shipped with the ACP 100 already applied over the implementation surfaces 50 of the electrode terminal plates (23, 33). This restrains the formation of the oxide film in the implementation surfaces 50 of the electrode terminal plates (23, 33). That is, this achieves the low contact resistance even when the power storage element 1a is implemented to the electronic circuit after being stored over a long period of time, improving the reliability in the implemented state. Additionally, with an extremely small-sized power storage element used as the power supply for card electronic device, the distance between electrode terminals of a positive electrode and a negative electrode is short. The use of not anisotropic but an isotropic conductive paint such as a silver paste and a carbon paste for implementation may make the conductive paint flow during the implementation and results in a short circuit between the electrode terminals. However, the power storage element 1a according to the working example uses the ACP 100 that behaves as an insulator in a surface direction; therefore, a short circuit does not occur between the electrode terminal plates (23-33) in principle. This also ensures a reduction in cost required for the members and storage compared with the conventional ACFs.

### Reliability

Next, the reliability of the power storage element according to the working example of the present invention was examined. Schematically, the conventional power storage element (hereinafter also referred to as a comparative example) and the power storage element according to the working example implemented using the ACF were manufactured as samples. The sample according to the comparative example and the sample according to the working example were actually implemented to circuit boards. An increase in contact resistance caused by an oxide film in the electrode terminal plate and presence/absence of increase in internal resistance caused by damage in the electrode body due to heat during the thermocompression bonding process were examined for the reliability of the respective samples. The samples of the comparative example and the working example only differ in the implementation form of the electrode terminal plates and the electronic circuit and the configuration as the power storage element is completely identical. Here, the laminated lithium primary battery (for example, FDK CORPORATION, CF052039(N)), which is disclosed as the product in above Non-Patent Literature 2, was manufactured as the sample according to the comparative example. The ACF was applied over implementation surfaces of the electrode terminal plates of the comparative example to configure the sample according to the working example. The material of the positive electrode terminal plate is aluminum and the material of the negative electrode terminal plate is copper.

### Contact Resistance

First, changes along with time in contact resistance caused by the oxide film were examined. Specifically, assuming that the sample of the comparative example was to be implemented after a lapse of a predetermined period (for example, 30 days) after being shipped as the product, after the lapse of the predetermined period from the completion of assembly, the ACP was applied over both surfaces of the electrode terminal plates under conditions similar to the working example. The samples of the comparative example and the working example were implemented to electronic circuits to couple the electrode terminal plates to the circuit boards. With this state, a room temperature storage test that stores the samples under a room temperature environment of 23±2° C. was conducted. Each time the predetermined number of days passed after starting the storage, the contact resistance was measured on the samples implemented to these circuit boards using a well-known four-terminal sensing. To implement the respective samples, a temperature of the jig for the sample of the comparative example was set to 170° C. and the thermocompression bonding was performed at a predetermined pressure (for example, 3 MPa) for eight seconds at this temperature. Except for the temperature of the jig being set to 120° C., the electrode terminal plates of the sample according to the working example were coupled to the circuit board by the thermocompression bonding under identical conditions.

The following TABLE 1 shows the results of this room temperature storage test.

TABLE 1

| | RESULT OF ROOM | | | | |
|---|---|---|---|---|---|
| | TEMPERATURE STORAGE TEST | | | | |
| | (CONTACT RESISTANCE) | | | | |
| | | | 180 | 270 | 360 |
| SAMPLE | 30 DAYS | 90 DAYS | DAYS | DAYS | DAYS |
| WORKING | GOOD | GOOD | GOOD | GOOD | GOOD |
| EXAMPLE | | | | | |
| COMPARATIVE | GOOD | GOOD | GOOD | FAIR | POOR |
| EXAMPLE | | | | | |

TABLE 1 shows that a contact resistance R (Ω) of R≦100 as “Good,” 100<R≦500 as “Fair,” and R>500Ω as “Poor.” In TABLE 1, the contact resistance of the sample of the comparative example after the lapse of 360 days, which became “Poor,” was actually 1000Ω or more. The following was confirmed according to the results shown in TABLE 1. The sample according to the working example did not have an increase in the contact resistance even at a lapse of nearly one year after the implementation. The sample according to the comparative example where the ACP was applied assuming the period up to the implementation remarkably increased the contact resistance at the lapse of 270 days. At a time point after nearly one year had passed, the contact resistance became 1000Ω or more, being in a substantially poor contact state.

### Internal Resistance

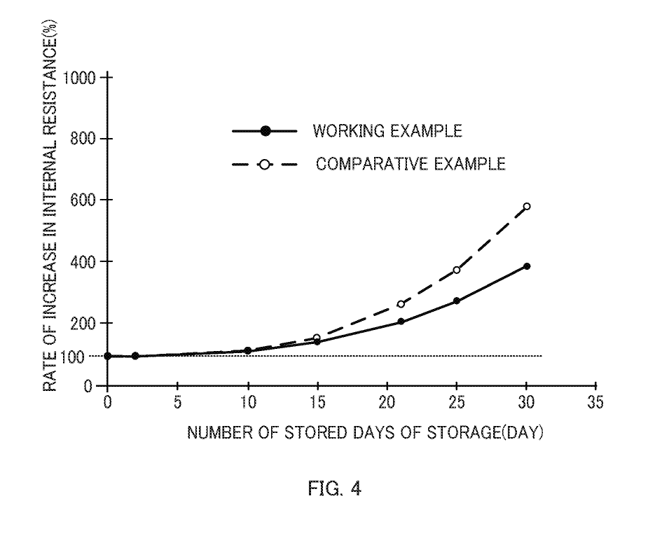

As described above, performing the thermocompression bonding on the electrode terminal plates to implement the power storage element possibly damages the electrode body due to the heat generated by the thermocompression bonding. Accordingly, an accelerated aging test that actually implements the samples of the comparative example and the working example to the circuit boards and stores the respective samples in the implemented state under high temperature, high humidity environment of 60° C. and 90% RH was conducted. After starting this accelerated aging test, the internal resistances of the respective samples were periodically measured by a well-known AC constant-current method (1 KHz, 10 mA). The implementation conditions for the respective samples are similar to the above-described room temperature storage test. FIG. 4 illustrates rates of increase in internal resistance (%) with the internal resistance at the start of the storage assumed as 100% as a relationship between the number of days elapsed after starting the storage and the internal resistances of the respective samples. As illustrated in FIG. 4, when 15 days passed, a tendency of the increase in internal resistance possibly caused by the damage in the electrode body during the thermocompression bonding was confirmed in the sample of the comparative example. After the lapse of 30 days, the rate of increase in internal resistance increased to more than 580% with the sample of the comparative example. Meanwhile, the rate of increase in internal resistance was 390% or less with the sample of the working example even after the lapse of 30 days. That is, it was able to be confirmed that the power storage element according to the working example can lower the temperature during the thermocompression bonding and therefore the electrode body is less likely to be damaged. An ability of lowering the temperature during the thermocompression bonding eases the temperature management and leads to a reduction in power consumption in the thermocompression bonding process, contributing to a cost reduction as the result.

### OTHER WORKING EXAMPLES

The copper and the aluminum are typical as the metal used for the electrode terminal plate of the laminate-type power storage element. However, the electrode terminal plate in the power storage element according to the working example of the present invention is not limited to these metals. As long as the metal forms the oxide film (such as a nickel and an iron), the metal is applicable. Needless to say, the metal may be an alloy.

The power storage element according to the working example of the present invention may have the configuration and the structure different from the ones illustrated in FIG. 1B that has been illustrated as a schematic diagram. For example, the electrode terminal plate may be configured of a well-known tab lead. Alternatively, a strip-shaped region projecting from a region over which the electrode material is applied may be formed integrally with an electrode current collector to guide a distal end of the strip-shaped region to the outside of the exterior body. That is, the electrode current collector itself, which is referred to as the core, may also serve as the electrode terminal plate. In any case, it is only necessary that the exterior body shaped in a flat bag internally seals the electrode body, which is formed by laminating the sheet-shaped positive electrode and negative electrode via the separator, together with electrolytic solution, and the ACP is applied over the implementation surfaces of the respective electrode terminal plates for both positive and negative electrodes, which are guided to the outside of the exterior body in an identical direction. Obviously, as long as the present invention has the structure that seals the flat plate-shaped electrode body with the laminated structure in the exterior body formed of the laminated films, the present invention is applicable to various kinds of laminate-type power storage elements (for example, a lithium secondary battery and an electric double layer capacitor) not limited to the lithium primary battery. Needless to say, the present invention can be applied to power storage elements having electrolytic solution impregnated in polymer such as in the case of polymer batteries. Further, the present invention can also be applied to power storage elements that do not use electrolytic solution itself such as in the case of all-solid-state batteries.

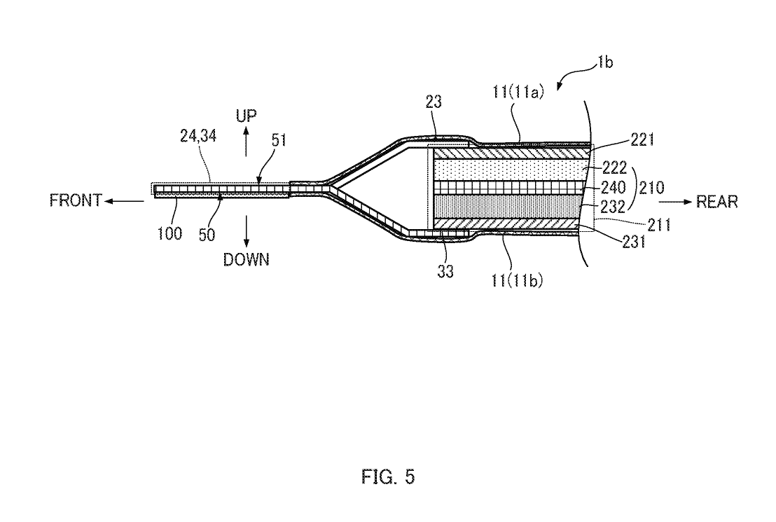

FIG. 5 illustrates an example of the laminate-type power storage element 1b using an all-solid-state battery 111. FIG. 5 corresponds to the cross section viewed from arrow b-b in FIG. 3A. As shown in the figure, the all-solid-state battery 111 housed in the exterior body 11 has a structure having formed to the top and the bottom surfaces of the laminated electrode body 110 current collectors (221, 231) made of metal foils. And the laminated electrode body 110 is made by sandwiching a sheet-type solid electrolyte (solid electrolyte layer) 240 between the sheet-shaped positive electrode (positive electrode layer) 220 and the sheet-shaped negative electrode (negative electrode layer) 230. Strip-shaped electrode terminal plates (23, 33) are respectively mounted to the current collectors (221, 231) with the electrode terminal plates (23, 33) thereof guided outside of the exterior body 11. Thereafter, ACP 100 is applied to the implementation face 50 of the electrode terminal plates (23, 33) by screen printing.

The laminated electrode body 210 is an integrally formed sintered body. A method such as baking the formed body obtained by compressing powdered material using a mold (hereinafter also called compression molding method) and a method using a well-known green sheet (hereinafter called green sheet method) can be given as methods for manufacturing the laminated electrode body 210. The materials are filled in layers (sheet form) inside the mold with the compression molding method, and the materials are filled in the order of a powdery positive electrode layer material including a positive electrode active material and a solid electrolyte as the material of the positive electrode layer 220, powdery solid electrolyte as the material of the solid electrolyte layer 240, and a powdery negative electrode layer material including a negative electrode active material and a solid electrolyte as the material of the negative electrode layer 230. Subsequently, the body formed by compressing in the stacking direction the powdery material layers layered in sheet shapes is baked. Hereby, a laminated electrode body 210 of an integrally formed sintered body is manufactured.

The laminated electrode body 210 is manufactured by the green sheet method in the following manner. A slurry positive electrode layer material including a positive electrode active material and a solid electrolyte, a slurry negative electrode layer material including a negative electrode active material and a solid electrolyte, and a slurry solid electrolyte layer material including a solid electrolyte are respectively formed in a sheet-shaped green sheet. Then the green sheet made of solid electrolyte layer material is sandwiched by the positive electrode layer material and the negative electrode layer material to form a layered body which is baked for manufacturing the laminated electrode body 210. Thereafter, the all-solid-state battery 111 is completed by applying silver paste to the top and the bottom surfaces of the manufactured laminated electrode body 210 and/or forming the current collectors (221, 231) by such as gold evaporation. And the strip-shaped electrode terminal plates (23, 33) only need to be mounted to the respective current collectors (221, 231) of the positive and negative electrodes with their electrode terminal plates (23, 33) guided outside of the exterior body 11 when the all-solid-state battery 111 is housed inside the exterior body 11 made of laminated films (11a, 11b).

What is claimed is:

1. A laminate-type power storage element, comprising:
an exterior body that is formed in a flat bag shape;
an electrode body that has a sheet-shaped positive electrode and a sheet-shaped negative electrode and that is sealed inside the exterior body;
a positive electrode terminal plate that is mounted to the positive electrode and that is made of a metal that forms an oxide film; and
a negative electrode terminal plate that is mounted to the negative electrode and that is made of a metal that forms an oxide film, wherein
the positive electrode terminal plate and the negative electrode terminal plate are guided in an identical direction from one margin of the exterior body to an outside of the exterior body, and have anisotropic conductive paint applied over respective principal surfaces thereof facing an identical side.

2. The laminate-type power storage element according claim 1 that is used as a power supply of a card type electronic device incorporating an electronic circuit and the power supply.
